(19) United States
(12) Patent Application Publication
(10) Pub. No.: US 2018/0083332 A1
(43) Pub. Date: Mar. 22, 2018

(54) IMPROVED CHARGE STORAGE DEVICE AND SYSTEM

(71) Applicant: Cambridge Display Technology Limited, Cambridgeshire (GB)

(72) Inventor: Jonathan Pillow, Hitchin (GB)

(73) Assignee: Cambridge Display Technology Limited, Cambridgeshire (GB)

(21) Appl. No.: 15/563,105

(22) PCT Filed: Mar. 21, 2016
(86) PCT No.: PCT/GB2016/050778

§ 371 Date: Sep. 29, 2017

(30) Foreign Application Priority Data
Mar. 31, 2015 (GB) 1505530.4

(51) Int. Cl. H01M 12/00; H01M 12/02; H01G 11/26; H01G 11/30; H01G 11/52

(52) U.S. Cl. CPC H01M 12/005; H01M 12/02; H01M 2300/0025; H01G 11/30; H01G 11/52; H01G 11/26

(57) ABSTRACT

A charge storage device and system comprises an anode assembly and a cathode assembly, each of the assemblies comprising a charge storage layer of a conjugated polymer material, wherein the conjugated polymer material of the charge storage layer of the cathode assembly is air stable and non-ionic in its discharged state, and wherein the conjugated polymer material of the charge storage layer of the anode assembly includes is air stable and non-ionic in its discharged state. The polymer materials are fully conjugated along the main chain, and are made by processes that do not involve oxidative or electrochemical polymerisation. The charge storage layers are formed from solutions of these polymers, and are amorphous and continuous.

### TECHNICAL FIELD

The present invention relates to an electrochemical charge storage device and system. Specifically, the invention relates to an improved polymer organic charge storage system for use as a hybrid supercapacitor/battery device.

### BACKGROUND

Over the last ten years, the rapid increase in the use of portable devices including smartcards, sensors and disposable electronics has put pressure on the development of more efficient methods, devices and systems to power these devices. As these devices have been steadily decreasing in size, smaller power sources have been developed which maintain or even have increased power storage capacity to ensure the power needs of these increasingly complex devices are met. Thin-film batteries were developed to achieve such purposes.

However, the thin-film batteries on the market all use lithium-ion or alkaline (Zn/MnO₂) technology. These can have various limitations regarding their safety, flexibility, recharging ability and maximum voltage and consequently such technologies are less than ideal.

It should be noted that conjugated polymers have been used before in the development of charge storage devices but the selected materials have typically been materials of relatively narrow bandgap, for example derivatives of polyaniline. In this context, wide bandgap is taken to mean a material that has relatively little or no absorption in the visible part of the spectrum, whereas narrow bandgap is taking to mean a material with significant absorption in the visible spectrum, and particularly in the green-red part of the spectrum. Although wider bandgap materials such as polyfluorene have also been investigated previously in charge storage devices, the conclusion drawn was that polyfluorene “is not an interesting material for battery electrodes” (Chem. Rev., 1997, 97, 207-281).

Previous attempts at making fully organic charge-storage devices have not been commercially acceptable. A suitable combination of stability, capacity and process feasibility has not been achieved. Indeed, the more significant problems that previous polymer organic charge storage devices have suffered are low chemical stability and low redox stability, both leading to problems with retaining the stored charge and maintaining charge storage capacities after numerous charging cycles.

Therefore, there is a need for an improved charge storage device, which is not only environmentally sustainable but is also effective. Preferably, the improved charge storage device should be non-pyrophoric, fully rechargeable and easily printable.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to an embodiment, there is provided a charge storage system comprising: an anode assembly and a cathode assembly, each of the assemblies comprising a charge storage layer of a conjugated polymer material, wherein the conjugated polymer material of the charge storage layer of the cathode assembly is air stable and non-ionic in its discharged state, and wherein the conjugated polymer material of the charge storage layer of the anode assembly includes is air stable and non-ionic in its discharged state.

Preferably, the conjugated polymer material of the charge storage layer of the cathode assembly may comprise at least one heteroatom that has an available lone pair of electrons capable of oxidizing to form a stable cation. The conjugated polymer material of the charge storage layer of the cathode assembly may comprise an aryl amino group. The material of the charge storage layer of the cathode assembly may comprise: diarylamine or triarylamine, or N-substituted carbazoles, phenoxazines, phenothiazines, or other cyclised triarylamines, thiophene derivatives such as thienothiophene or dibenzothiophene, benzofuran derivatives, xanthene derivatives, porphyrins, phthalocyanins. The conjugated polymer material may comprise a polyfluorene formulation modified with an aryl group, such as a diaryl or triaryl amino group.

Additionally or alternatively, the conjugated polymer material of the charge storage layer of the anode assembly may be configured to form a stable anion. The conjugated polymer material may comprise hydrocarbons, such as polyfluorene and derivatives thereof, or polyaniline. The conjugated polymer material may comprise polyfluorene with two or more substituents selected from one or more of: aryl or alkyl substituents. The two substituents may comprise alkoxy substituted alkyl groups, for example methoxyethyl or an oligomer of polyethylene glycol. The material may comprise co-polymerised fluorine with low-LUMO groups such as 2,1,3-benzothiadiazole or 2,4,6-triphenyl-1,3,5-triazine or 2,3-diphenylquinoxaline, fluorenone, and derivatives of any of these materials.

Additionally or alternatively, the conjugated polymer material may be a copolymer. The conjugated polymers may comprise cross-linked conjugated polymer chains. The cross-linked conjugated polymer chains may comprise benzocyclobutene (BCB)-alkene. The conjugated polymers may comprise polar side groups. The polar side groups may comprise ether groups.

Optionally, the charge storage system may further comprise zinc oxide (ZnO). The charge storage system may further comprise electrical contacts. The electrical contacts may comprise gold or indium tin oxide or fluorine tin oxide and/or aluminum zinc oxide and/or antimony tin oxide, zinc oxide and/or other suitable elements or compounds including but not restricted to copper, zinc, tin, silver, gold, aluminium, titanium, bismuth or iron metals or alloys.

Preferably, the polymers may be tuned collectively to deliver charge release properties for a specific application, such as without limitation, more battery-like or supercapacitor-like behaviour.

In an additional or alternative embodiment, there is a provided a process for manufacturing the charge storage system described herein. The conjugated polymers may be made into the charge storage system by solution processing before a cross-linking process is undertaken such that the conjugated polymers are rendered insoluble. The charge storage layers formed by the solution processing of the conjugated polymers may be amorphous and continuous. The conjugated polymers may be made by processes that do not involve oxidative and/or electrochemical polymerisation.

In an additional or alternative embodiment, there is a provided a non-blended charge storage system comprising cross-linked conjugated polymer chains. The conjugated polymer may be a copolymer. The conjugated copolymer may comprise conjugated polycyclic hydrocarbons or heterocyclic systems. The conjugated polymer may comprise hydrocarbons, such as polyfluorene. The polyfluorene may have two substituents at its 9-Position. The two substituents may include aryl or alkyl substituents. The substituents may comprise alkoxyl substituted alkyl groups.

Optionally, the conjugated polymers may comprise a heterocyclic system. The heterocyclic system may comprise benzo-fused heterocycle. The benzo-fused heterocycle may comprise benzothiadiazole. The benzothiadiazole may comprise 2,1,3 benzothiadiazole. The cross-linking groups may be based on chemical reactions between oxetanes or epoxides or benzocyclobutenes and alkenes or alkynes, and in which cross-linking is initiated by thermal or photochemical means with the aid of an optional catalyst. The polymer may further comprise a stabilizing substituent including aryl, diaryl or triaryl amino groups. Optionally, the charge storage system may further comprise zinc oxide (ZnO).

In an additional or alternative embodiment, there is a provided an electrochemical charge storage device comprising a p-type polymer layer, an n-type polymer layer, a separator layer disposed between the p-type polymer layer and the n-type polymer layer wherein the electrochemical charge storage device has a cell voltage of at least 1.5 V. Preferably, the voltage may be at least 2 V or from 2-3 V.

In an additional or alternative embodiment, there is a provided a process of preparing the cross-linked polymers described herein.

In an additional or alternative embodiment, there is a provided a method of tuning the storage capacity of an electronic storage device comprising first and second conjugated organic polymer layers separated by an electrolyte, the method comprising: selecting a cathode material with a first electrode potential; and selecting an anode material with a second electrode potential, wherein the HOMO of the cathode and the LUMO of anode achieve a potential difference for the charge storage device of between 0.5V to 4V.

The potential difference may be between 1.5V to 3.5V. The cathode material may be selected based on the workfunction tuned to the HOMO. The HOMO level of the cathode material may be tuned to match an appropriate electrode contact material. The compounds of the electrode contact material may include gold (Au), indium tin oxide (ITO), copper (Cu), chromium (Cr), cobalt (Co), nickel (Ni), palladium (Pd), platinum (Pt), tin (Sn), tungsten (W) and iron (Fe).

The anode material may be selected based on the workfunction tuned to the LUMO. The compounds of the electrode contact material include gold or indium tin oxide or fluorine tin oxide and/or aluminum zinc oxide and/or antimony tin oxide, zinc oxide and/or other suitable elements or compounds including but not restricted to copper, zinc, tin, silver, gold, aluminium, titanium, bismuth or iron metals or alloys.

In an additional or alternative embodiment, there is a provided a method of producing the charge storage system or device described herein, comprising: printing the polymer films and laminating with a separator. The polymer films may be printed onto one or more substrates. The method may further comprise the step of encapsulating the polymer films.

In an additional or alternative embodiment, there is a provided a use of the charge storage system described herein in a hybrid supercapacitor/battery device. The hybrid supercapacitor may be the charge storage device in a smartcard. The hybrid supercapacitor may be the charge storage device in a sensor.

In an additional or alternative embodiment, there is a provided a device containing the charge storage system described herein.

The features of each of the above aspects and/or embodiments may be combined as appropriate, as would be apparent to the skilled person, and may be combined with any of the aspects of the invention. Indeed, the order of the embodiments and the ordering and location of the preferable features is indicative only and has no bearing on the features themselves. It is intended for each of the preferable and/or optional features to be interchangeable and/or combinable with not only all of the aspect and embodiments, but also each of preferable features.

### BRIEF DESCRIPTION OF THE DRAWINGS

For better understanding of the aspects and/or embodiments described herein and to show how the same may be carried into effect, reference will now be made, by way of example only, to the accompanying figures, in which:

FIG. 1 is a side-sectional view of an exemplary energy storage device;

FIG. 2 is a side-sectional view of the energy storage device of FIG. 1 detailing the HOMO and LUMO positions of the anodic and cathodic portions of the storage device; and

FIGS. 3A and 3B are graphs depicting experimental results obtained in which the charge-storage layers are in the range of 80-100 nm thick.

It will be appreciated that although features from each of the embodiments may be identified by different reference numerals in the figures and throughout the description, similar features including the properties and functionality attributed thereto, from one embodiment may be interchangeable with those of another embodiment.

### DETAILED DESCRIPTION

According to the present invention there is provided a charge transport storage system as specified in the claims.

The conjugated polymer material of the charge storage layer of the cathode assembly and the anode assembly is air stable and non-ionic in its discharged state. The polymer or polymers preferably have fully conjugated backbones—i.e. having no saturated links in the main chain. The conjugated polymer materials are preferably not made by oxidative polymerization. Typically Suzuki or Yamamoto polymerisation is employed. This gives rise to solution processable materials which can be easily purified and analysed.

References will now be made in detail to the various aspects and/or embodiments, examples of which are illustrated in the accompanying figures. In the following detailed description, numerous specific details are set forth in order to provide a thorough understanding of the invention. However, it will be apparent to one of ordinary skill in the art that the invention may be practiced without these specific details.

Overview of Battery Structure

Herein described is an electrochemical energy storage device. The term “energy storage device” has been chosen to encapsulate, without limitation, electrochemical capacitors, electrochemical batteries, hybrid capacitors, hybrid super capacitors and pseudocapacitors. The term should be construed to include both single-use batteries and multi-use batteries that are capable of repeated discharge and recharge. It should therefore be appreciated that when the term storage device is used, it is intended to include reference to each of batteries and capacitors, unless the passage specifies to the contrary.

The term “conjugated” used herein means they chemical system with de-localised or mobile charge carriers, and should be construed to include all suitable types of aromatic and non-aromatic compounds, including non-planar or twisted molecular systems, unless the passage specifies to the contrary.

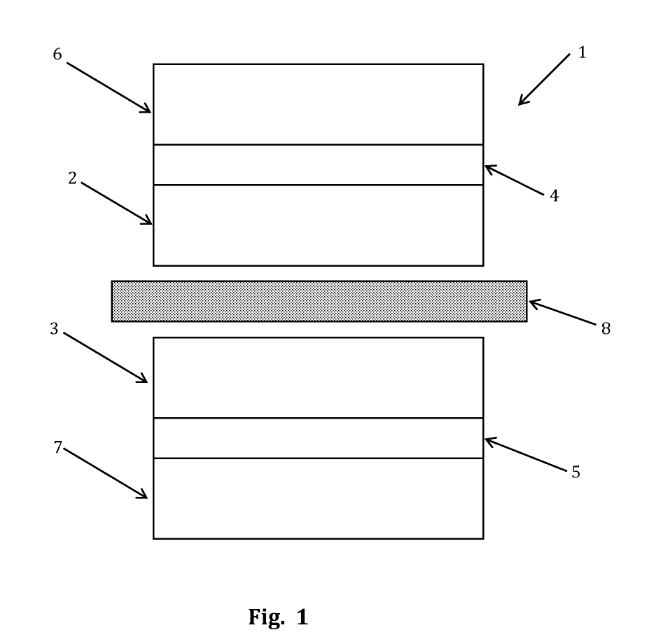

FIG. 1 provides a representation of a polymer organic energy storage device 1 according to one embodiment. In this embodiment, storage device 1 is depicted to comprise polymer organic charge-storage layers 2 and 3, conducting charge-collecting layers 4 and 5, wherein each charge-storage layer 2 and 3 and charge-collecting layer 4 and 5 are affixed to substrate 6 and 7, respectively. It should be noted that although FIG. 1 depicts the presence of substrates 6 and 7 in the storage device, these features are optional. Substrates 6 and 7 may be advantageously provided to offer additional rigidity and strength to the system and to aid the manufacture process; however, either or both may be omitted if sufficient support is provided by either or both of the charge-collecting layers 4 and 5. A separator 8 separates each of the respective pairs of charge-storage layers 2 and 3, charge-collecting layer 4 and 5 and substrate 6 and 7.

The part of the device including the combination of a charge collecting layer and charge storage layer on each side of the separator may be referred to herein as an “electrode assembly”. A charge-collecting layer may also be referred to as an “electrode”.

In this embodiment, the charge-storage layers 2 and 3 and, optionally also the conducting charge-collecting layers 4 and 5, comprise conjugated polymers.

The conjugated polymers may be for example a homopolymer or a copolymer, for example, conjugated polycyclic hydrocarbons or heterocyclic systems. A particular charge storage layer may comprise a discrete polymer material or, alternatively, it may comprise a blend of polymer materials. In this context, blend means of two or more distinct polymer materials provided in some sort of mixture or combination substantially without chemical bonds between the different polymer materials within the blend. Note that a distinct polymer material in a blend may nevertheless be a homopolymer or a copolymer.

Preferably, the charge storage layers comprise polymer organic materials selected from hydrocarbons and modified hydrocarbons, for example polyfluorenes. The conjugated polymer may comprise special polyfluorenes, for example fluorenes having two substituents at their 9-position. The kind of substituents may include aryl, alkyl or other suitable substituents. One example of a substituent group may be alkoxy substituted alkyl groups, optionally, substituted branched, alkyl groups having one to twenty carbon atoms, wherein the alkyl group may for example be methoxyethyl or an oligomer of polyethylene glycol.

In one example, the conducting charge-collection layers may comprise a metal or metal oxide or another suitable conducting material. For example, a charge-collecting layer may include indium tin oxide (ITO). Additionally or alternatively, the conducting charge-collection layers may comprise compounds such as SnO2:F fluorine tin oxide (FTO) and/or ZnO:Al, aluminium zinc oxide (AZO) and/or SnO2:Sb, antimony tin oxide (ATO), zinc oxide and/or other suitable elements or compounds including but not restricted to copper, zinc, tin, silver, gold, aluminium, titanium, bismuth or iron metals or alloys. Additionally, the surfaces of the charge-conduction materials might be modified in a variety of ways that could, for example, enhance adhesion to the substrate or to the charge-storage layer, or could enhance the ability of charges to pass between the charge-conduction material and the charge-storage material.

An embodiment is that the charge-storage layer 2 and charge-collecting layer 4 (with a similar arrangement for charge-storage layer 3 and charge-collecting layer 5) are made from a film. These films may be sandwiched together on each of substrates 6 and 7, respectively, wherein substrates 6 and 7 are preferably non-conductive substrates. Film thickness of a charge storage layer may be in any suitable range for achieving battery and super capacitor behaviour. In a thin film embodiment, charge storage layer thicknesses are in the range 100 nm to 100 μm, or preferably 125 nm to 1000 μm.

As mentioned previously, where the device has sufficient rigidity, it is possible that one or more of the substrates 6, 7, will not be included. Indeed, in certain embodiments no substrate at all is included. Whether or not to include a substrate on one or both of the electrode assemblies depends for example on desired rigidities and may also depend on fabrication process preferences. An example of this would be if a charge-collection layer 4 and/or 5 was thick enough and consisted of a strong enough material. Examples of a suitable material include, but are not limited to, copper, zinc, iron or aluminium.

Where they are included, it is preferable that substrates 6 and 7 include at least one material selected from a group consisting of glass or plastics such as polyethylene terephthalate and derivatives and mixtures thereof that could include composite materials. Separator 8 is provided between each of the respective pairs of charge-storage layers 2 (and 3), charge-collecting layer 4 (and 5) and substrate 6 (and 7) to ensure these electrode assemblies are separated. The separator 8 can conduct ions, but not electrons. In one embodiment, separator 8 may be selected from a group of porous materials that are made from fibrous materials such as cellulose, nylon, polytetrafluoroethylene or derivatives, or other polymeric materials. In a further embodiment, the separator 8 may be selected from a group of materials that are inherently non-porous, but which have been perforated to enable porosity. These materials could include polymers such as nylon, polytetrafluoroethylene, polypropylene or polyethylene. In a preferred embodiment, the separator material is relatively compressible, for example by having sponge-like properties, so that the removal of electrolyte during the charging process can be accommodated by the relative shrinkage of the separator.

Separator 8 is impregnated with an electrolyte that contains both anions and cations that are mobile and can penetrate the cathodic or anodic charge-holding materials 2 or 3 respectively. It will be appreciated that separator 8 should have enough electrolyte/ionic liquid for each of the charge-storage layers to be completely oxidised or reduced (with their counter-ions) and for there still to be ionic conductivity.

It will be appreciated that it may be preferable to have the charge-storage layers be as thick as possible; for example, up to 1 mm for each layer.

Conversely, the charge-collection layers may comprise a very thin film of up to 1 mm or more; for example, where a substrate is not required. It will be appreciated that where a substrate is required, the thickness of the substrate can range from non-existent up to 1 mm or more.

One advantage of the aforementioned design is that it may be used in thin-film, printed charge-storage in conjunction with other integrated printed electronic applications.

However, it will be appreciated that the described storage device structure may also be used for other uses including with thicker devices.

Further advantages of the aforementioned structure include the provision of a flexible, lightweight charge storage device providing high voltage with good energy and power delivery.

Exemplary Systems

To improve the stability and efficiencies of anodic and cathodic processes and/or to improve the rate and stability of ion conduction, it has been determined that additional constituents may be added to charge-storage layers 2 (and 3) and/or charge-collecting layers 4 (and 5). The optimization of processes at the anode and/or the cathode facilitates improved stability and efficiency.

Anode Assembly:

An embodiment of the anode assembly is prepared by applying a thin layer of zinc oxide onto a film of indium tin oxide on a glass using a literature procedure such as that described in Advanced Materials, 2013, 25, 4340-4346. On to this is spin-coated a thin film of the n-type polymer at a concentration of 10 mg/ml in toluene, forming a thickness of approximately 100 nm. This is cross-linked under a nitrogen atmosphere on a hot-plate at 180° C. for 1 hour and then allowed to cool.

Cathode Assembly:

In an example of the cathode assembly, a thin film of indium-tin oxide is used as the charge-collection layer on a glass substrate. On to this is spin-coated a thin film of the p-type polymer at a concentration of 10 mg/ml in toluene, forming a thickness of approximately 100 nm. This is cross-linked under a nitrogen atmosphere on a hot-plate at 180° C. for 1 hour and then allowed to cool.

The present invention recognizes that optimizing the materials used in storage device 1 can provide overall improved capacity, stability and efficiency of the storage device 1 itself. While intending not to be bound by theory, it is believed that the energy level of the highest occupied molecular orbital (HOMO) with respect to the vacuum level of the cathode material is closely related to the electrode potential of the cathode while the energy level of the lowest unoccupied molecular orbital (LUMO) of the anode polymer is related to the electrode potential of the anode. The difference between the two electrode potentials provides the potential difference (voltage output) of the charge storage, which can be tuned by considering the HOMO of the cathode material and the LUMO of the anode material. As the energy stored within a capacitor or supercapacitor is proportional to the square of the potential difference, while that of a battery is proportional to the potential difference, it is advantageous to have a higher voltage drop, as long as this can be achieved without compromising the stability of the stored charges.

In one example of an anode assembly, polyfluorene is used as the conjugated polymer charge storage material. Although in this example polyfluorene is described, it will be appreciated that other fluorene derivatives may be provided as the polymer and/or copolymer material forming the charge storage layer(s). Polyfluorene is preferable as it is intrinsically an effective electron transport material with a relatively shallow LUMO energy; this provides overall redox stability and a relatively wide potential difference for the stored charge. In addition, it should be noted that substitutions to the C9 positions by introducing e.g. different aryl or alkyl groups can be used to make small changes to the energy level of the LUMO.

In another example, fluorene can be co-polymerised with other low-LUMO groups such as 2,1,3-benzothiadiazole or 2,4,6-triphenyl-1,3,5-triazine. Further examples of low-LUMO moieties include 2,3-diphenylquinoxaline, fluorenone, and derivatives of any of these materials; along with other bifunctional units with low-lying LUMO levels that can be incorporated into the polymer, and that form radical anions that are stable an unreactive upon reduction. Having a deeper LUMO means that it is easier for charges to be injected from a charge-collecting layer which may be a higher-workfunction material. These can be more easily accepting of solution processing conditions, for example zinc oxide (ZnO) can be spun onto, coated, from normal solutions—while lower workfunction materials such as calcium (Ca) metal cannot be spun on top of without reacting with the solvent (or trace moisture). It should be noted that low workfunction materials can be deposited by known evaporation methods. Where a lamination approach is used to assemble the charge storage device, alternative methods of depositing the materials are preferred.

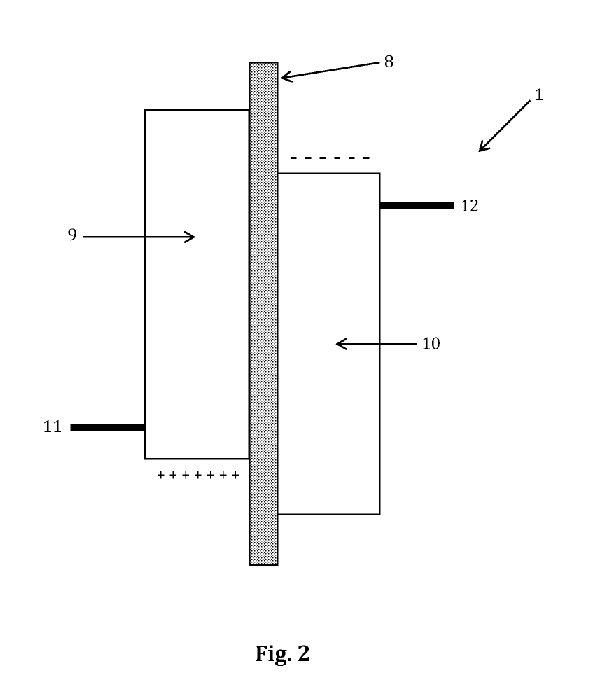

FIG. 2 is a side-sectional view detailing the HOMO and LUMO positions of the cathode and anode of the energy storage device of FIG. 1. FIG. 2 not only depicts the HOMO and LUMO positions of the cathode 9 and anode 10 of storage device 1, but also illustrates the preferred workfunctions of their electrical contacts 11 and 12, respectively.

In one embodiment, it is preferable that the HOMO level of the polymer material of cathode 9 is tuned to match an appropriate electrode contact material. It will be appreciated that many compounds with appropriate workfunctions are available, for example gold (Au) or indium tin oxide (ITO). Other appropriate compounds include copper (Cu), chromium (Cr), cobalt (Co), nickel (Ni), palladium (Pd), platinum (Pt), tin (Sn), tungsten (W) and iron (Fe), though it should be noted that some of these are passivated by a thin oxide layer which must be considered when considering work functions.

Due to the tendency of aromatic cation systems to be relatively reactive with other aromatic systems by virtue of electrophilic addition mechanisms, it is preferable that materials for the cathodic charge-storage material are selected that form unreactive oxidation products; for example, the system may comprise at least one heteroatom that has an available a lone pair of electrons capable of oxidising to form a stable cation. In one example, the material selected includes diarylamine systems or triarylamine systems that can form, for example, stable aminium salts such as the commercially available tris(bromophenyl)aminium hexachloroantimonate. Advantageously, triarylamine moieties can readily be introduced into other conjugated polymers such as polyfluorene by Suzuki coupling or other palladium (Pd)-catalysed reactions. Other appropriate compounds include but are not limited to N-substituted carbazoles, phenoxazines, phenthiazines or other cyclised triarylamines, thiophene derivatives such as thienothiophene or dibenzothiophene, benzofuran derivatives, xanthene derivatives, porphyrins, phthalocyanins.

It is advantageous to improve the ability of the charge storage device to allow counter-charges from the electrolyte separator to pass through the polymer layer to balance the charges that are injected. It has been determined that ions are conducted best through polar materials with functional groups such as ether, though the need for functional groups will vary according to the inherent polarity of the other polymer moieties and the structure and charge density of the ions being considered.

It should be noted that the embodiments disclosed as examples herein should be regarded as having charge storage layers of chemically distinct polymer (or copolymer) and that blended layers or materials are not used in these examples. A “polymer blend” or “polymer mixture” is a member of a class of materials analogous to metal alloys, in which at least two polymers are blended together to create a new material with different physical properties. Notwithstanding the examples disclosed herein, it is possible to conceive other embodiments that do imply blends of polymers. In particular, it is possible to imagine blends of polymers that are fully mixed together and that do not phase separate to any appreciable extent.

In one example, materials present in the charge storage layers 2, 3 are selected that have polar groups attached to the side of the conjugated chains. Preferably the selected materials form continuous domains with polar material intrinsically mixed with the conjugated units to enable the passage of ions. The polar side groups promote movement of ions in electrolyte (e.g. side groups based on ethylene glycol oligomers) and to prevent side chain reactions.

One of the major known charge loss-mechanisms with conjugated polymers is when the polymers in their charged states become soluble and can dissolve in the electrolyte and pass through separator 8. To combat this issue, in some embodiments, cross-linking technology is used to covalently bind the polymer chains together thereby preventing them from moving. Various cross-linking chemistries are known, for example benzocyclobutene (BCB)-alkene reactions, epoxides or oxetanes. Preferably, BCB-alkene reactions are used, as they are known to be relatively unreactive compared to oxygen-rich systems such as epoxides or oxetanes and are therefore less likely to interact unfavourably with the other electrochemical processes in the device.

Other appropriate cross-linking chemistries include other sigmatropic reactions such as the Diels-Alder reaction between an alkene or equivalent and a diene or equivalent, disulphide or sulphide links by vulcanisation, or condensation reactions between electrophiles and nucleophiles, or by any other intermolecular reaction or cross-linking process, as can be learned from an appropriate literature source. By cross-linking, the polymer chains become insoluble and can no longer dissolve and pass through the separator, preventing the loss of charge through a redox shuttle process; i.e. prevention of charge leakage/degradation of electrode into electrolyte. The expectation while including cross-linking monomers into a polymer is to ensure that, after the cross-linking process, every polymer chain has at least two connections to neighbouring polymer chains, resulting in the whole film becoming insoluble. It will be recognised that a washing step can be undertaken to remove any uncrosslinked polymer chains, and thereby maximise stability, but that this is an unwanted process step, the requirement for which can be minimised by ensuring that the cross-linking reaction is selected to as to be fully effective.

The electrolyte may be chosen so that the ions are entirely stable to the chemistry and electrochemistry of the device structure chosen and are as mobile as possible through the device. A number of ionic liquids may be suitable in which the ions have sufficiently weak interactions with each other that they form a liquid at room temperature; for example 1-butyl-1-methylpyrrolidinium bis(trifluoromethylsulfonyl)imide. This invention can take advantage of these various advantageous properties and is not bound by any particular class of electrolyte, as different electrolytes are likely to be optimal for the different conjugated polymers. In an alternative embodiment, the electrolyte consists of a salt such as tetramethylammonium tetrafluoroborate that is dissolved in a polar organic solvent such as propylene carbonate. In either case, it is preferable that the liquid electrolyte has a sufficiently low melting point such that it remains liquid over the entire temperature range that the device is expected to operate under.

It is expected that at least one substrate material will be included in charge storage device 1 to provide a firm platform and to provide physical strength to the device 1. An exception to this can occur if one or both of the charge-collection layers is sufficiently thick and robust as to provide the necessary strength without a substrate being present. It will be appreciated that substrate 6 and 7 may comprise the same substrate material and/or different substrate materials. A wide range of materials can be used for this purpose, of which glass is a common example or plastic materials such as polyethylene, nylon or polyethylene terephthalate can provide flexibility. A second substrate may optionally be included in the device 1 and is particularly advantageous if the device is prepared in two halves, which are then laminated together. If a second substrate is not included, or additional to the second substrate being included, it is preferable that an encapsulation layer(s) is provided to exclude oxygen and water from the system, depending on the energy levels of the materials chosen. This is particularly preferable if any of the reduction or oxidation potentials involved in the system fall outside the window available to water or oxygen.

This is due to the redox processes forming new ionic species in the manor analogous to a battery but with the high charge mobility along the polymer chains that is analogous to a supercapacitor. In practice, advantages from both systems will be apparent, as the embodiments described herein provide moderate charge storage densities but with relatively high power densities. The above optimization generally illustrates how choice of materials and other parameters can be selected and modified to optimise the balance between the two extremes to suit particular applications.

The charge-storage device described above is expected to act as a hybrid between a supercapacitor and a battery. It is possible that one or both electrode assemblies can be tuned to deliver more battery like or more super capacitor like properties. For example, in one embodiment both electrode assemblies, and particularly the charge storage layers, are configured to deliver more battery like properties. For example, in another embodiment both electrode assemblies, and particularly the charge storage layers, are configured to deliver more super capacitor like properties. In another embodiment, the different electrode assemblies, and particular the charge storage layer of each, are configured to provide battery and super capacitor behaviour such that the device overall behaves as a hybrid with desired levels of properties of each.

For example, in a situation in which the n-type and p-type materials are used directly with no further additions or modifications, it is expected that the charge-storage density will be at a maximum, but that the speed of ion movement will be relatively low, which would limit the power availability of the system. This system would be the most battery-like. In an alternative embodiment, modifications to the polymer film could enable much faster ion movement, which would enable higher power delivery from the device. It is however expected that the steps required to obtain this result would require the loss of charge-storage density, and so the resulting system would be less like a battery and more like a supercapacitor. Possible methods to achieve this increase in ion conductivity include the incorporation of ion-transporting units such as polyethylene glycol or oligoethylene glycol, either as a blend with the charge-storage polymer, or by modifying the structure of the charge-storage polymer so as to have the ion-transporting units directly attached.

Fabrication

Storage device 1 may be assembled by a variety of methods.

In one embodiment, storage device 1 is assembled by first preparing charge-storage layers 2 and 3 and charge-collecting layers 4 and 5 on their respective substrate 6 and 7, wherein the charge-storage layers 2 and 3 and charge-collecting layers 4 and 5 preferably comprise polymer films. These layers may then be laminated together along with separator 8.

In an alternative embodiment, cross-linkable layers and/or orthogonal solvents may be used so that the multilayer device can be prepared in a single vertical direction. Conventional methods well known to those in the art may be employed to fabricate the cross-linkable layers. It will be appreciated that cross-linking applied to the polymer component(s) optimizes the stability of the storage device 1. In particular, this allows more reactive metals to be used, for example, as the charge-collecting layers on the anode side of the device 1 as this enables a closer energy match between the metal and the LUMO of the conjugated polymer, thus allowing easier electron injection into the device while charging.

The fluorene polymer preparation may be by Suzuki polymerization as described in U.S. Pat. No. 6,169,163 and WO 00/53656 (CDT). Various ways of making fluorene and triaryl amine polymers and copolymers are summarised in the book “Organic Light-Emitting Materials and Devices” Ed. Zhigang Li and Hong Meng, Taylor & Francis [2007] ISBN 1-57444-574-X, especially in Chapter 2 which includes examples of both Suzuki-Coupling Polymerization and Yamamoto Polymerisation. It will be appreciated that the person skilled in the art could prepare the polymers using these methods or any other known method.

The p-type polymer was made by the Suzuki polymerisation of diamine dibromide monomer

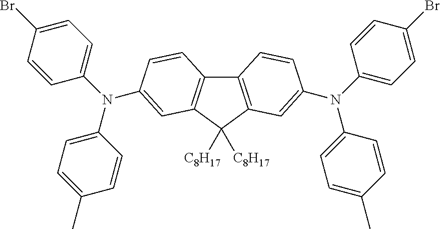

(49.5 mol %) along with 2,7-bis(4,4,5,5-tetramethyl-1,3,2-dioxaborolan-2-yl)-9,9-dioctylfluorene (25 mol %), 2,7-bis(4,4,5,5-tetramethyl-1,3,2-dioxaborolan-2-yl)-9,9-bis(3′,5′-dihexylphenyl)fluorene (15 mol %) and

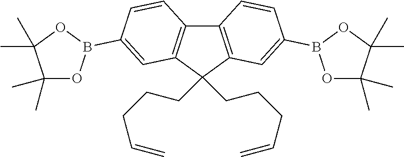

(5 mol %) and

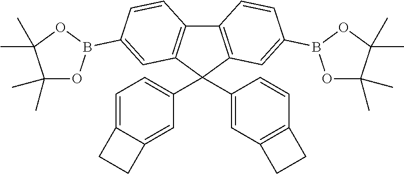

(5 mol %).

The n-type polymer was made by the polymerisation of 4,7-dibromo-2,1,3-benzothiadiazole (50 mol %) with 2,7-bis(4,4,5,5-tetramethyl-1,3,2-dioxaborolan-2-yl)-9,9-dioctylfluorene (30 mol %),

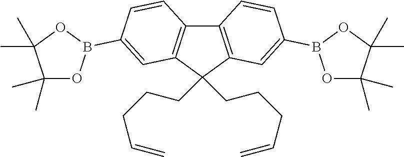

(10 mol %) and

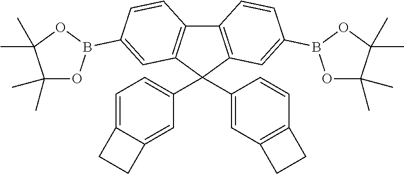

(10 mol %).

The p-type polymer was spin-coated onto a film of ITO on glass from a 10 wt % solution in toluene to form a film that was ˜100 nm thick. The anode assembly was prepared as outlined above with a coating of zinc oxide on the ITO and the n-type material was spin-coated in the same way. Both films were then baked on a hot-plate under a nitrogen atmosphere for 1 hour at 180° C. and allowed to cool. The polymer films were then laminated together, with a piece of filter paper (Whatman, grade 1) that had been soaked in ionic liquid 1-butyl-1-methylpyrrolidinium bis(trifluoromethylsulfonyl)imide acting as the separator. The device assembly was then clamped together and tests were performed under a nitrogen atmosphere to ensure that water did not enter the device.

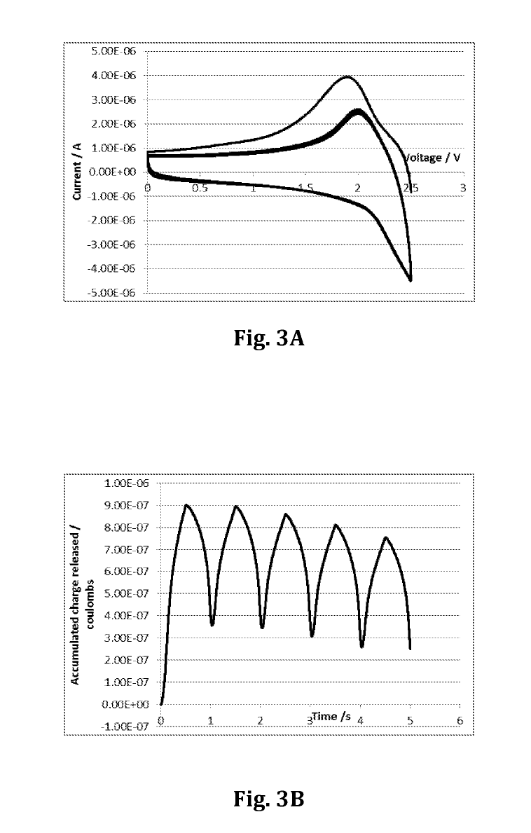

FIGS. 3A and 3B are graphs depicting experimental results obtained in which the charge-storage layers are in the range of 80-100 nm thick. In particular, tests were performed by applying a voltage of 2.5V for 5 s and then lowering the voltage to 0V at a rate of 5 Vs⁻¹ before cycling between 2.5V and 0V for a further 4 cycles. This clearly showed that more charge was released on the first sweep stage, indicating that the initial 5 s charging phase had indeed led to charge being stored in the device, and that it was functioning as a battery. It also showed that the stability of the system was good, with almost all of the injected charge between returned, and with almost the same amount of charge being stored during each of the charge-discharge cycles. The system is therefore performing as an effective charge-storage device.

To conclude, we have described a device containing two different conjugated polymers, with the charges injected into the HOMO and LUMO of the two polymers respectively, and in which both polymers whilst in their discharged (lower energy) state are air stable, completely non-ionic (with no metal ions or organic ions) and can be fabricated into the device by solution processing before a cross-linking process is undertaken to render them insoluble—
the conjugated polymers are furthermore made by processes that do not involve oxidative or electrochemical polymerisation, and
the films that are formed by the solution processing of these polymers are amorphous and continuous.

Although the present invention has been described in terms of specific exemplary embodiments, it will be appreciated that various modifications, alterations and/or combinations of features disclosed herein will be apparent to those skilled in the art without departing from the scope of the invention as set forth in the following claims.

In summary, a charge storage device and system comprises an anode assembly and a cathode assembly, each of the assemblies comprising a charge storage layer of a conjugated polymer material, wherein the conjugated polymer material of the charge storage layer of the cathode assembly is air stable and non-ionic in its discharged state, and wherein the conjugated polymer material of the charge storage layer of the anode assembly includes is air stable and non-ionic in its discharged state. The polymer materials are fully conjugated along the main chain, and are made by processes that do not involve oxidative or electrochemical polymerisation. The charge storage layers are formed from solutions of these polymers, and are amorphous and continuous.

1. A charge storage system comprising:
an anode assembly and a cathode assembly, each of the assemblies comprising a charge storage layer which comprises a conjugated polymer material,
wherein the conjugated polymer material of the charge storage layer of the cathode assembly is air stable and non-ionic in its discharged state, and
wherein the conjugated polymer material of the charge storage layer of the anode assembly includes is air stable and non-ionic in its discharged state.

2. The charge storage system of claim 1, wherein the conjugated polymer material of the charge storage layer of the cathode assembly comprises at least one heteroatom that has an available lone pair of electrons capable of oxidizing to form a stable cation.

3. The charge storage system of claim 2, wherein the conjugated polymer material of the charge storage layer of the cathode assembly comprises an aryl amino group.

4. (canceled)

5. The charge storage system of claim 2, wherein the conjugated polymer material comprises a polyfluorene formulation modified with an aryl group, such as a diaryl or triaryl amino group.

6. The charge storage system of claim 1, wherein the conjugated polymer material of the charge storage layer of the anode assembly is configured to form a stable anion.

7. The charge storage system of claim 6, wherein the conjugated polymer material comprises hydrocarbons, such as polyfluorene and derivatives thereof, or polyaniline.

8-9. (canceled)

10. The charge storage system of claim 6, wherein the material comprises co-polymerised fluorine with low-LUMO groups such as 2,1,3-benzothiadiazole or 2,4,6-triphenyl-1,3,5-triazine or 2,3-diphenylquinoxaline, fluorenone, and derivatives of any of these materials.

11. The charge storage system of claim 1, wherein the conjugated polymer material is a copolymer, or the conjugated polymers comprise cross-linked conjugated polymer chains.

12-13. (canceled)

14. The charge storage system of claim 1, wherein the conjugated polymers comprise polar side groups.

15-18. (canceled)

19. The charge storage system of claim 1, wherein the polymers are tuned collectively to deliver charge release properties for a specific application, such as without limitation, more battery-like or supercapacitor-like behaviour.

20-23. (canceled)

24. A charge storage system according to claim 1, wherein the charge storage layers are non-blended and comprise cross-linked conjugated polymer chains.

25. The charge storage system of claim 24, wherein the conjugated polymer comprises a copolymer.

26-30. (canceled)

31. The charge storage system of claim 24, wherein the conjugated polymers comprise a heterocyclic system.

32-34. (canceled)

35. The charge storage system of claim 24, wherein:
the cross-linking groups are based on chemical reactions between oxetanes or epoxides or benzocyclobutenes and alkenes or alkynes, and in which cross-linking is initiated by thermal or photochemical means with the aid of an optional catalyst.

36-37. (canceled)

38. A charge storage system according to claim 1, comprising a p-type polymer layer, an n-type polymer layer, a separator layer disposed between the p-type polymer layer and the n-type polymer layer wherein the electrochemical charge storage device has a cell voltage of at least 1.5 V.

39-40. (canceled)

41. A method of tuning the storage capacity of an electronic storage device comprising first and second conjugated organic polymer layers separated by an electrolyte, the method comprising:
selecting a cathode material with a first electrode potential; and
selecting an anode material with a second electrode potential,
wherein the HOMO of the cathode and the LUMO of anode achieve a potential difference for the charge storage device of between 0.5V to 4V.

42. (canceled)

43. The method of claim 41, wherein the cathode material is selected based on the workfunction tuned to the HOMO.

44-45. (canceled)

46. The method of claim 41, wherein the anode material is selected based on the workfunction tuned to the LUMO.

47-48. (canceled)

49. A method of producing a charge storage system or device of claim 1, comprising:
printing the polymer films and laminating with a separator.

50. The method of claim 49, wherein the polymer films are printed onto one or more substrates.

51. (canceled)

52. A hybrid supercapacitor/battery device comprising the system of claim 1.

53-55. (canceled)
